(19) United States
(12) Patent Application Publication
(10) Pub. No.: US 2015/0278560 A1
(43) Pub. Date: Oct. 1, 2015

(54) Apparatus for Transmission of Signals from a Metal Housing

(71) Applicant: ENDRESS+HAUSER GMBH+CO. KG, Maulburg (DE)

(72) Inventor: Thomas Blodt, Basel (CH)

(21) Appl. No.: 14/433,912

(22) PCT Filed: Sep. 19, 2013
(86) PCT No.: PCT/EP2013/069454

§ 371 Date: Apr. 7, 2015

(30) Foreign Application Priority Data
Oct. 8, 2012 (DE) 10 2012 109 539.6

(51) Int. Cl. G06K 7/10

(52) U.S. Cl. CPC G06K 7/10009; G06K 7/10336

(57) ABSTRACT

An apparatus for transmission of signals from a housing formed at least partially of metal for identification with the assistance electromagnetic waves (RFID), comprising at least a first housing opening, and a coil arrangement arranged in the housing for producing a magnetic field, wherein the magnetic flux density, which enters or leaves the coil arrangement has a vector ( [symbol] ₘₐₓ) with a maximum magnitude, wherein the vector ( [symbol] ₘₐₓ) or its opposite vector (− [symbol] ₘₐₓ) points toward the first housing opening.

The invention relates to an apparatus for transmission of signals from a housing formed at least partially of metal. Preferably, the apparatus serves for transfer of data in storage media with the assistance of electromagnetic waves (RFID).

In automation technology, especially in process automation technology, field devices are often applied, which serve for determining, optimizing and/or influencing process variables. Serving for registering process variables are sensors, such as, for example, fill level measuring devices, flow measuring devices, pressure- and temperature measuring devices, conductivity measuring devices, etc., which register the corresponding process variables, fill level, flow, pressure, temperature, and conductivity, respectively. Serving for influencing process variables are actuators, such as, for example, valves or pumps, via which the flow of a liquid in a pipeline section, respectively the fill level in a container, can be changed. Referred to as field devices are, in principle, all devices, which are applied near to the process and which deliver or process information relevant to the process. In connection with the invention, the terminology, field devices, thus includes also remote I/Os, radio adapters, and, in general, all devices, which are arranged at the field level. A large number of such field devices are manufactured and sold by the firm, Endress+Hauser. RFID systems are used, for example, in order to identify field devices.

An RFID system is composed of a transponder, which is located in a housing and contains an identifying code, as well as a reading device for the read-out of this identification. An NFC system enables supplementally an information path in the opposite direction. Disadvantageous in the case of RFID and NFC transponders is the metal, for instance metal coated, housing of most field devices. Such housings are essentially impervious to electromagnetic waves in the region needed for RFID.

An object of the invention is to provide an apparatus, which improves the transmission of RFID or NFC signals from a metal housing.

This object is achieved by the apparatus as defined in claim 1. Such an apparatus for transmission of signals from a housing formed at least partially of metal, especially for identification with the assistance of electromagnetic waves (RFID), includes at least a first housing opening, and a coil arrangement arranged in the housing for producing a magnetic field, wherein the magnetic flux density, which enters or leaves the coil arrangement, has a vector with a maximum magnitude and the vector or its opposite vector points toward the first housing opening.

The housing opening can be, for example, a cable feedthrough opening or cable gland. The coil arrangement includes one or more coils having at least one, preferably, however, a number of windings, wherein each coil can contain include no, one or more coil cores. If a magnetic field is produced by supplying a voltage to the coil arrangement, the magnetic field occurs at a certain location of the coil arrangement. If the coil arrangement, for example, does not have a coil core, the magnetic field passes through the two coil openings of the coil arrangement. If the coil arrangement has, for example, a coil core, then the magnetic field is at the surface of the coil core of the coil arrangement. The vectorial magnetic field has at the location, where the magnetic field passes through the coil arrangement, a vector, which is maximum. This vector or its opposite vector is according to the invention to pass through the housing opening with stretching. Here, stretching means multiplication of a vector with a scalar, which is greater than one.

The signal can be data, which transmit to a reading device information concerning certain process variables. Furthermore, the reading device can, in this way, obtain information concerning whether the transponder has completely transmitted the data or a function interference is present on the part of the transponder or by the partially metal wall.

If the maximum vector or its opposite vector points toward the housing opening, then in the case of a fixed size of the housing opening, according to the invention, the transmission power, which leaves the housing, becomes maximum. As a result, the subject matter of claim 1 achieves the object of the invention.

In an additional form of embodiment, the housing can have a second housing opening, and the vector or its opposite vector points toward the first housing opening or toward the second housing opening. A field line, to which the vector is tangent, extends essentially through the first housing opening and through the second housing opening. The second housing opening enables that the field lines, which leave from the first housing opening, reenter from the second housing opening. In this way, the leaving and entering field lines do not have to share a single housing opening. In this way, mutual superimposings and mutual interferences are prevented.

Furthermore, the coil arrangement can assume an irregular shape, such as e.g. a meander like, fractal or fractal like form. These forms are advantageous for manufacturing reasons. Alternatively, the cross section of the coil arrangement can also be square, round, elliptical. Other cross sections are likewise possible.

In a further development, there is arranged in the housing an electronics unit, which is connected with the coil arrangement by means of a high-frequency conductor, especially a coaxial cable. Advantageous in the case of use of a high-frequency conductor, respectively a coaxial cable, is that the signals to be transmitted cannot be disturbed by electrical and/or magnetic fields.

In an additional form of embodiment, the electronics unit includes a high-frequency and/or a low-frequency interface (HF-interface), wherein the HF-interface is connected with the coil arrangement via an impedance matching means and/or a balun. A balun can, in this case, act as an impedance converter for power matching.

In an additional form of embodiment, the coil arrangement includes at least one coil and at least one coil core, wherein the coil is arranged in such a way asymmetrically on the coil core that the produced magnetic field is asymmetric. If the coil has a smaller separation from a first end region of the coil core than from a second end region of the coil core, then the flux density of the magnetic field is greater at the first end region than at the second end region. However, the spreading of the magnetic field at the second end region is then greater than at the first end region of the coil core.

In an additional form of embodiment, the at least one coil core of the coil arrangement includes structures features on its surface, which are so embodied that they influence the field distribution of the magnetic field leaving the coil arrangement. Such structural features can be, for example, constrictions, widenings, chamfers, roughenings, funnels and/or other materials. Such structures on the surface of the coil core lead to the fact that the magnetic field is amplified, focused, widened, rotated or is brought into a preferential direction or a larger part of the field distribution remains within the housing.

In an additional form of embodiment, the coil core is formed of a ferromagnetic and/or diamagnetic and/or paramagnetic material, such as, for example, PVC and/or a synthetic material, such as a plastic. Advantageously, in such case, is the broad product palette of materials, which are available for selection to serve as the coil core.

In an additional form of embodiment, the coil arrangement includes a plurality of subcoils, which are electrically connected with one another and/or with a signal ground and/or with a signal ground of the electronics unit. Advantageous in the case of a coil arrangement with a number of grounded subcoils is that each subcoil produces its own contribution to the voltage. The voltages of the subcoils then add to form a total voltage.

In an additional form of embodiment, the coil arrangement includes at least one winding and is embodied as an electrically open electrical circuit. Forming between the open end regions of the electrical current circuit of the coil arrangement is a capacitance, which can be utilized for producing electromagnetic waves.

In an additional form of embodiment, the coil arrangement is connected via a connecting line electrically to the housing wall. If an open end region of one of the connecting lines of the coil arrangement is connected to the housing wall, then the housing wall forms one electrode of the capacitance and the other open end region of the connecting line of the coil arrangement forms the counter electrode of the capacitance.

In an additional form of embodiment, at least one of the housing openings is closed by a disk of plastic and/or glass, and/or the coil arrangement is arranged in a separate chamber open toward at least one housing opening.

The object of the invention is achieved further by an RFID system, which includes the apparatus of the invention. An RFID system with an apparatus of the invention enables that data can be read from a metal housing by means of a reading device. The object of the invention is achieved, moreover, by a field device having a reading device and an RFID system of the invention. A field device with an RFID system of the invention enables the transmission of data through a metal wall.

The object of the invention is likewise achieved by use of an apparatus of the invention for Bluetooth (IEEE 802.15.1), WLAN (IEEE 802.15.1), HIPERLAN, IWLAN, wireless HART or some form of NFC. By applying the apparatus of the invention, data of the above mentioned radio networks can likewise be transmitted past partially metal walls.

The invention will now be explained based on the appended drawing, the figures of which show as follows:

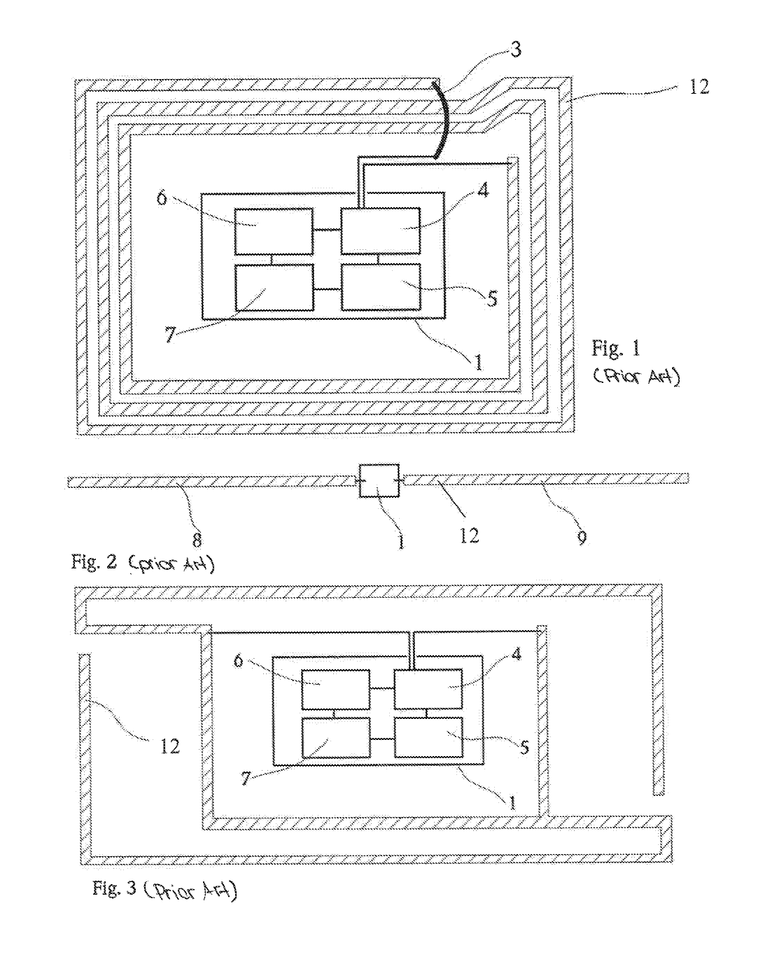

FIG. 1 an RFID transponder with a coil arrangement wound around the electronics unit (state of the art);

FIG. 2 an RFID transponder with an elongated coil arrangement (state of the art);

FIG. 3 an RFID transponder (state of the art);

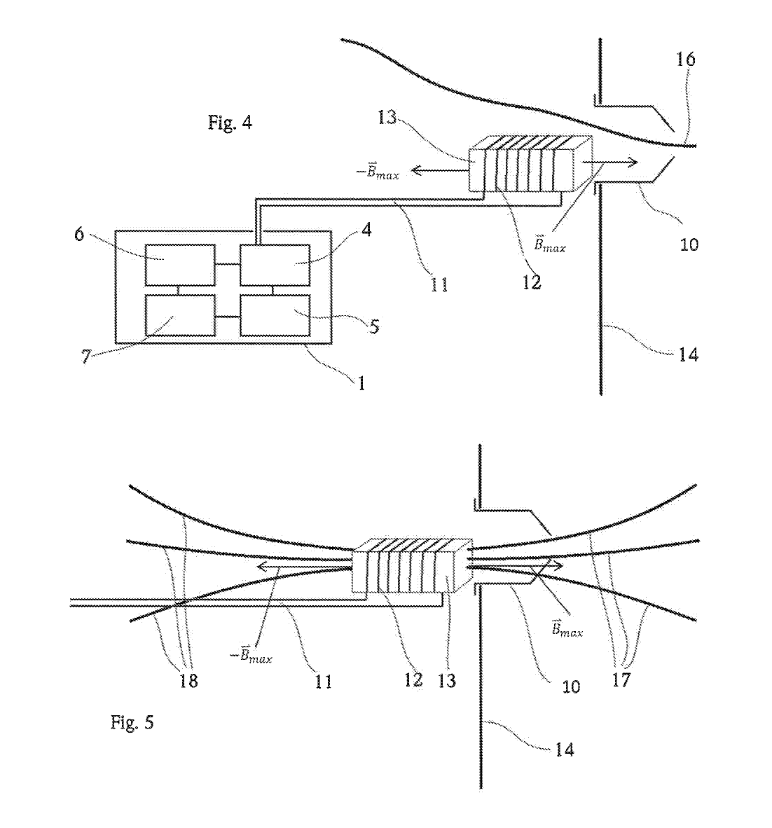

FIG. 4 an electronics unit with a coil arrangement in a metal housing;

FIG. 5 a coil arrangement in a metal housing;

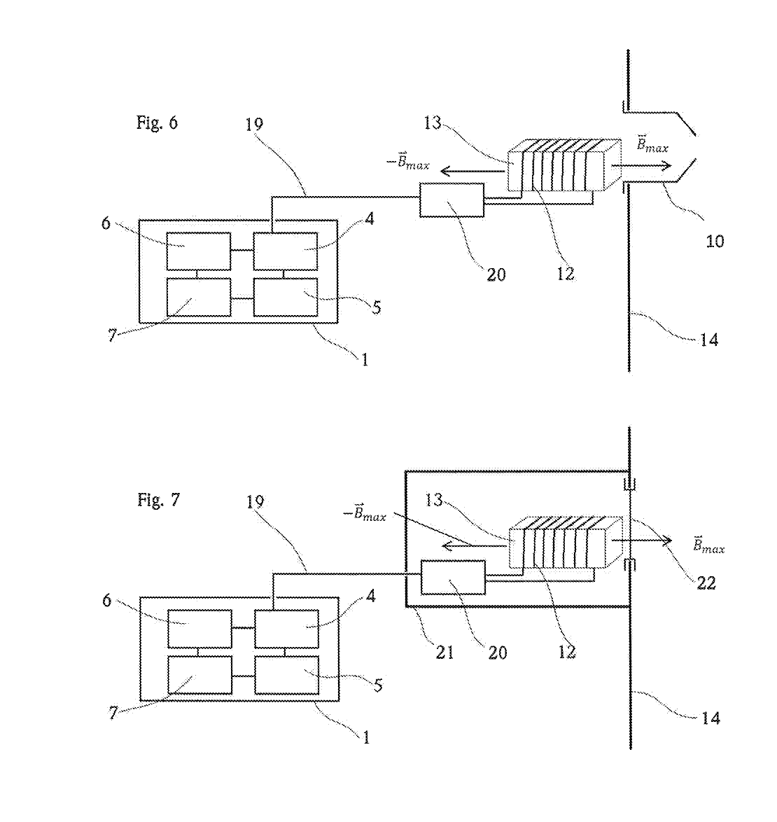

FIG. 6 a coil arrangement arranged in a metal housing and electrically connected with the electronics unit by means of a coaxial cable or a high-frequency conductor;

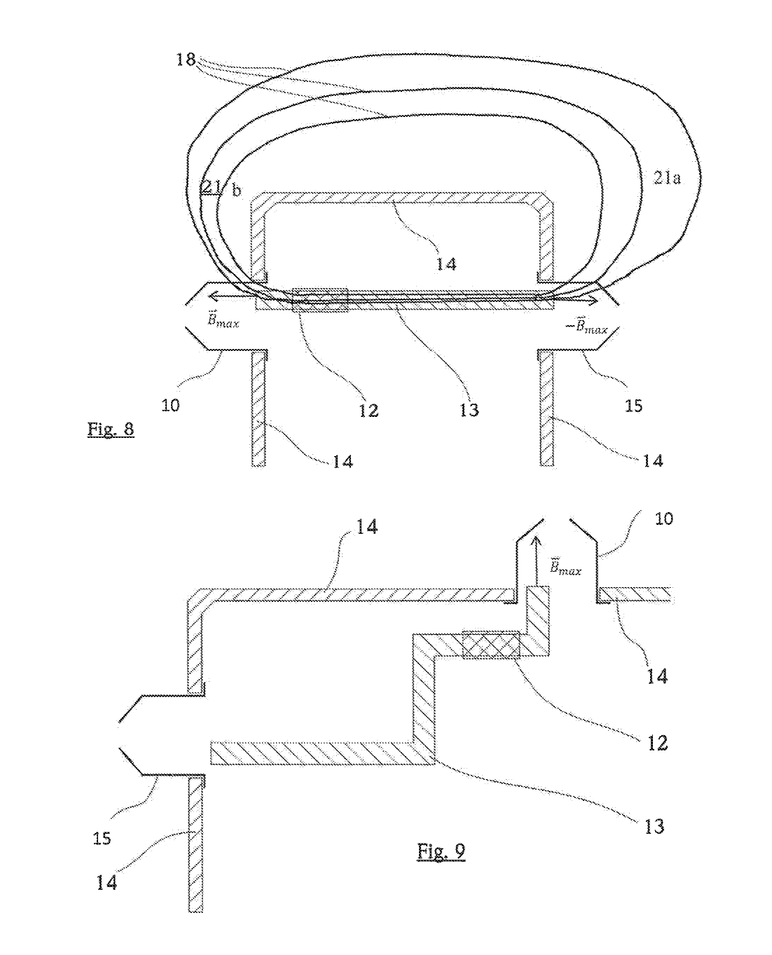

FIG. 7 an electronics unit with a coil arrangement arranged in a separate chamber and behind a disk;

FIG. 8 a coil arrangement having a coil, which is situated asymmetrically on a coil core and arranged in a housing having two housing openings;

FIG. 9 a coil arrangement having a coil, which is situated asymmetrically on a kinked coil core and arranged in a housing having two housing openings;

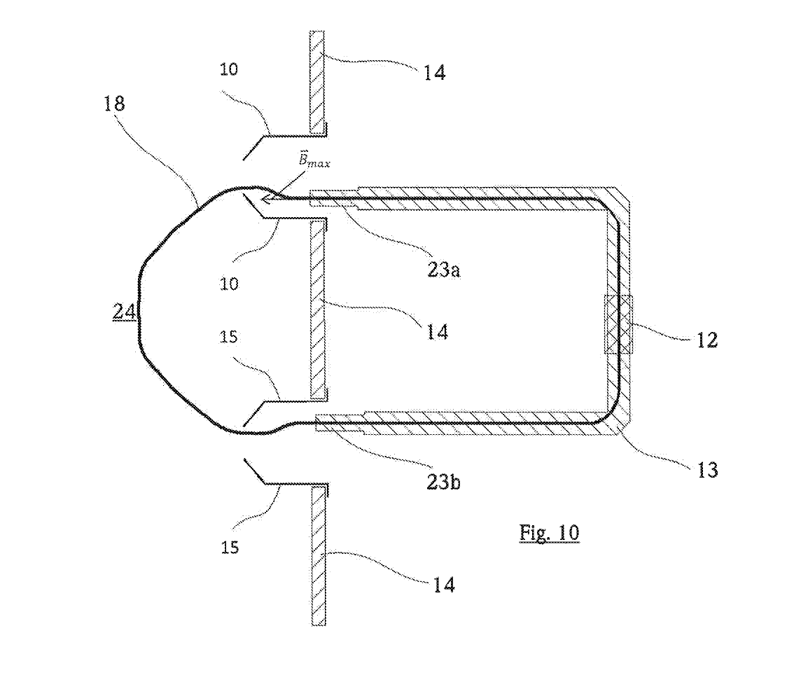

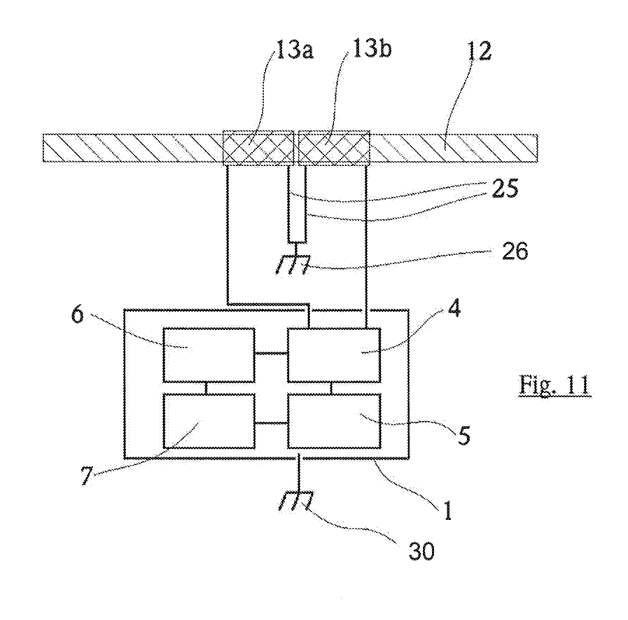

FIG. 10 a coil arrangement with a U-shaped coil core, which has structural features at its end faces, arranged in a housing having two housing openings;

FIG. 11 a coil arrangement of two subcoils connected with a signal ground, wherein the two subcoils are electrically connected with an electronics unit connected with signal ground;

FIG. 12 a coil arrangement having an electrically open coil, which is electrically connected with the electronics unit;

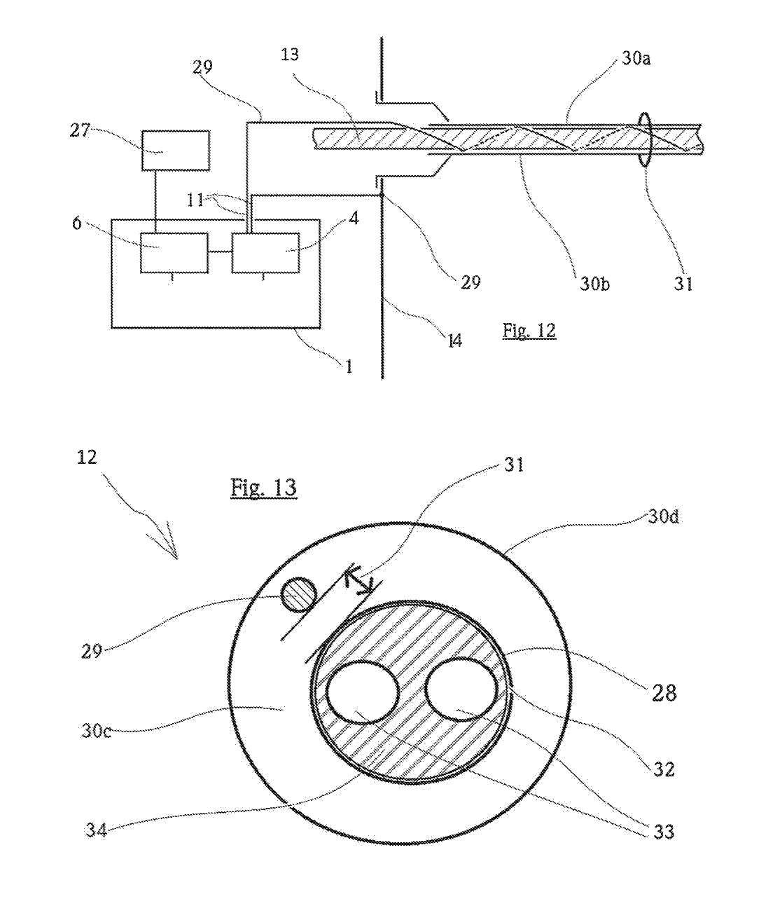

FIG. 13 a cross section of a coil arrangement having an electrically open coil, in the case of which the wire is arranged spaced from insulating material.

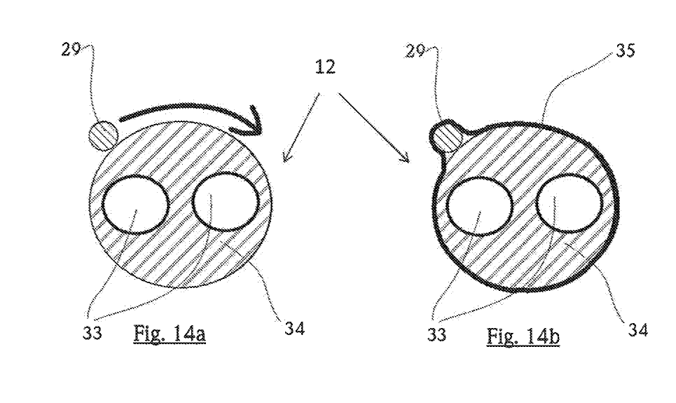

FIG. 14a a cross section of a coil arrangement having an electrically open coil without cladding

FIG. 14b a cross section of a coil arrangement having an electrically open coil with a shrink tube

An apparatus for transmission of signals from a housing formed partially of metal includes an RFID system, which according to the state of the art is composed of an RFID transponder, in which the desired data are stored, as well as a reading device. The RFID transponder (FIG. 1) is composed of an electronics unit 1, which is surrounded by a coil arrangement 2. Depending on embodiment of the coil arrangement 2, a jumper 3 is necessary, in order electrically to connect the electronics unit 1 and the coil arrangement 2.

Electronics unit 1 is composed of a high-frequency interface, respectively HF-interface, 4, which receives the transmission power of the reading device taken up via the coil arrangement 2 and which can output a modulated signal via the coil arrangement 2. This modulated signal can be composed of values stored in a data memory 7, which can be, for example, a ROM or an EPROM. The transmission power of the reading device is forwarded by the HF-interface 4 to a voltage supply 5 and stored there. The supply unit 5 supplies the electronics unit with energy. A logic unit 6 is provided as control unit.

Another known form of embodiment in the state of the art (FIG. 2) involves use of a coil arrangement 2 in the form an open dipole, composed of two open lines 8, 9.

FIG. 3 shows another form of embodiment of an RFID-antenna from the state of the art, where the coil arrangement 2 has a special shape.

A coil arrangement 12 of the invention (see FIG. 4) is arranged in the housing in such a way that the magnetic flux density, which enters or leaves the coil arrangement 12, has a vector [symbol] ₘₐₓ having a maximum magnitude and the vector [symbol] ₘₐₓ points toward the first housing opening 10.

To this end, a connecting line 11 extends between coil arrangement 12 and electronics unit 1, i.e. the electronics unit 1 is located not within, but, instead, outside of the coil arrangement 12. The coil arrangement 12 includes a coil core 13. Especially, the coil arrangement 12 can be integrated in a plastic housing. Feedthrough cables 16 located in a first housing opening 10 degrade the range supplementally in small measure (see FIG. 4); sensible for this would be the application exclusively of further cable feedthrough caps for cable.

The coil arrangement 12 in FIG. 5 forms magnetic field lines 17, 18 on both ends. A conductive housing wall 14 interferes with the closed field lines. Especially at high frequencies, thin metal surfaces considerably degrade electromagnetic waves. In given cases, the electromagnetic waves can be completely reflected by the metal surfaces.

Possible operating frequencies are, for example, 13.56 MHz, 6.78 MHz and 27 MHz, 125 MHz. However, also lower and higher frequencies are possible, for example, 125 kHz, 433 MHz, 920 MHz or 5.8 GHz.

Due to the distance between the HF-interface 4, respectively electronics unit 1, and the coil arrangement 12, a variant of the invention (FIG. 6) uses a high-frequency conductor 19, which is embodied as a coaxial cable. For this, the HF-interface 4 is connected directly to a connecting line 11. As a result, an impedance matching 20 and/or a balun 20, in the case of application a coaxial cable 19, is necessary between HF-interface 4 and coil arrangement 12. In this way, the connection between the HF-interface 4 and the impedance matching 20 can be selected for an especially suitable line impedance. By application of existing housing openings 10, 15, this variant of the invention is especially suited for retrofitting existing devices.

Another variant is a disk 22 of synthetic material, such as plastic, and/or glass and/or a separate chamber 21, as shown in FIG. 7.

Another variant is shown in FIG. 8. In such case, a coil arrangement 12 is arranged on a coil core 13 in such a manner that the field lines 18 can extend through the first and the second housing openings 10, 15 of an electrically conductive housing.

For a uniform field distribution outside of the housing, a positioning of the coil arrangement 12, as a rule, centrally on the coil core 13 is advantageous. The exact field distribution is influenced through the dimensions, shape and materials of the (field-)device. Numerical simulation can be used to design a housing or a region of a housing in such a manner that a certain field distribution is achieved or favored.

If the coil arrangement 12 is situated to a significant degree asymmetrically toward one end of the coil core 13, there results in the region 21b lying near this end a somewhat higher field density and in an oppositely lying region 21a a somewhat lesser field density as well as a somewhat greater range. In FIG. 8, the first housing opening 10 and the second housing opening 15, which are embodied as cable glands, are not electrically conductive. Therefore, the field lines penetrate the first and second housing openings 10, 15. FIG. 8 is a two-dimensional section; the field lines extend in general throughout the total surrounding space.

Another form of a coil arrangement 12 is shown in FIG. 9. The coil core has three sharp bends, wherein the coil is arranged asymmetrically on the coil core 13. Such a coil core 13 can be a blanked element, for example.

An advantageous variant is shown in FIG. 10. Provided in the region of a metal housing wall 14 are two housing openings 10, 15, which are embodied as cable glands. The coil core 13 is U-shaped, in order to extend to the two housing openings, 10, 15, which are embodied as cable glands. Provided on coil core 13 is a coil. This coil arrangement 12 provides field lines 18, which have in a region 24 outside of the housing a higher field density than the example of an embodiment in FIG. 5 with only one housing opening. Depending on the selected details such as dimensions, materials, turns number, operating frequency and other influences, the region 24 can extend, for example, from 5 to 800 mm from the metal housing wall 14.

Provided at the end regions of the coil core 13 are structural features 23a, 23b for influencing the field distribution outside of the housing. The structural features 23a, 23b are embodied as narrowings at the two end regions of the coil core. Shown in this variant (FIG. 10) are two partially electrically conductive housing openings 10, 15 in the form of electrical cable feedthroughs, which are penetrated by field lines 18 only insignificantly (depending on frequency).

FIG. 11 shows the coil arrangement 12 composed of two subcoils 13a, 13b. In this way, there can be achieved, for example, an adapted field distribution using one coil core 13 with two end regions and a plurality of cable glands, wherein the plurality of subcoils need not correspond to the number of end regions of the coil core 13. Subcoils can also be distributed on a plurality of individual coil cores.

Moreover, for example, according to FIG. 11 with the help two subcoils 13a, 13b, a symmetric energy and data transmission can occur between electronics unit 1 and coil arrangement 12. This is especially advantageous, in case the HF-interface 4 is electrically symmetrically designed, in which case, a balun 20 is not necessary. Depending on selected winding direction of the subcoils 13a, 13b, the circuitry 25 provides a connection with a first signal ground 26 of the subcoils 13a, 13b and/or with a second signal ground 30 of the electronics unit 1.

The described coil arrangements can be used not only with different frequencies, but, instead, for example, also for other, uni- as well as bidirectional data connections, for example, Bluetooth (IEEE 802.15.1), WLAN (IEEE 802.11 . . . ), HIPERLAN, IWLAN, wireless HART and NFC.

Especially suited for data transmissions without necessary energy transfers is an embodiment according to (FIG. 12). In such case, there is added to the conventional coil core 13 a further cable 29. This is led straight along the other cable 28 or wound helically thereon and serves as coil arrangement 12 to provide a variant which is especially advantageous for middle to low frequencies (for example, 125 kHz . . . 30 MHz).

In the case of such a coil arrangement 12 (FIG. 12), an electrical connection of the HF-interface 4 to the metallized housing is sensible. This can require galvanic isolation between a device electronics 27 and the HF-interface 4, which is implemented, for example, by a capacitive component (capacitor or corresponding circuit board structure).

In case the signals in the coil core 13 have overlapping and/or even-numbered divisors and/or an even-numbered multiple of the frequencies of the HF-interface 4, a shielding of the cable 28 is sensible. In this case, a small separation 31, for example, 0.1 mm, should be selected between the cable 29 and the shielding 32 (FIG. 13). In such case, the cable 29 (for example, a copper wire) is connected with the HF-interface 4, which has the separation 31 from the shielding 32. This shielding can be composed of, for example, one or more conductive films or one or more wire braids, as well as a mixture thereof. Located within the shielding is a two-wire line, composed of two conductors and insulating material 34. The coil arrangement 12, which surrounds the insulating material 34, includes a reinforced cladding.

A cost effective and easily implemented field device is composed of a cable 29, which in a first step is wound helically on a two-wire line 33 (FIG. 14a), wherein the two-wire line 33 is composed of two conductors and insulating material 34 but has no shielding. The coil arrangement 12 should have a defined length, which depends on the cable length, the operating frequencies and the transmitting- and/or receiving characteristics. In a second step a long shrink tube 35 is emplaced (FIG. 14b), which has a length such that it surrounds the cable 29, which is embodied as a copper wire.

### LIST OF REFERENCE CHARACTERS

1. electronics unit
2. coil arrangement according to the state of the art
3. jumper
4. HF-interface
5. voltage supply
6. logic unit
7. data memory
8. open line
9. open line
10. first housing opening of non-conductive material
11. connecting line
12. coil arrangement of the invention
13. 13a) first coil core, 13b) second coil core
14. housing wall
15. second housing opening of non-conductive material
16. feedthrough cable
17. magnetic field lines
18. magnetic field lines
19. high-frequency conductor
20. impedance matching
21. separate chamber
22. disk
23. structural features 23a and 23b
24. region
25. circuitry
26. first signal ground
27. device electronics
28. wire
29. cable
30. second signal ground
31. separation
32. shielding
33. two-wire line
34. insulating material
35. shrink tube

1-14. (canceled)

15. An apparatus for transmission of signals from a housing formed at least partially of metal for identification with the assistance of electromagnetic waves (RFID), comprising:
at least a first housing opening; and
a coil arrangement arranged in the housing for producing a magnetic field, wherein:
the magnetic flux density, which enters or leaves said coil arrangement, has a vector ( [symbol] ₘₐₓ) with a maximum magnitude, wherein the vector ( [symbol] ₘₐₓ) or its opposite vector (− [symbol] ₘₐₓ) points toward said first housing opening.

16. The apparatus as claimed in claim 15, wherein:
the housing has a second housing opening and the vector ( [symbol] ₘₐₓ) or its opposite vector ( [symbol] ₘₐₓ) points toward said first housing opening or toward said second housing opening and a field line, to which the vector ( [symbol] ₘₐₓ) is tangent, extends essentially through said first housing opening and through said second housing opening.

17. The apparatus as claimed in claim 15, further comprising:
an electronics unit is arranged in the housing, wherein:
said electronics unit and said coil arrangement are connected by means of a high-frequency conductor.

18. The apparatus as claimed in claim 17, wherein:
said electronics unit includes a high-frequency and/or a low frequency interface, said interface is connected with said coil arrangement via an impedance matching means and/or a balun.

19. The apparatus as claimed in claim 15, wherein:
said coil arrangement includes at least one coil and at least one coil core, and said coil is arranged in such a way asymmetrically on said coil core that the produced magnetic field is asymmetric.

20. The apparatus as claimed in claim 19, wherein:
said at least one coil core includes structural features on its surface, which are so embodied that they influence the field distribution of the magnetic field.

21. The apparatus as claimed in claim 19, wherein:
said coil core is formed of a ferromagnetic and/or diamagnetic and/or paramagnetic material, such as, PVC and/or a synthetic material, such as a plastic.

22. The apparatus as claimed in claim 19, wherein:
said coil arrangement includes a plurality of subcoils, which are electrically connected with one another and/or with a first signal ground and/or with a second signal ground of said electronics unit.

23. The apparatus as claimed in claim 22,
said coil arrangement includes at least one winding and is embodied as an electrically open electrical circuit.

24. The apparatus as claimed in claim 19, wherein:
said coil arrangement is electrically connected with a connecting line to the housing wall.

25. The apparatus as claimed in claim 15, wherein:
at least one of said housing openings is closed by a disk of plastic and/or glass; and/or that said coil arrangement is arranged in a separate chamber open toward at least one of said housing openings.

26. An RFID system, comprising:
a reading device; and
an apparatus for transmission of signals from a housing formed at least partially of metal for identification with the assistance of electromagnetic waves (RFID), comprising: at least a first housing opening; and a coil arrangement arranged in the housing for producing a magnetic field, wherein: the magnetic flux density, which enters or leaves said coil arrangement, has a vector ( [symbol] ₘₐₓ) with a maximum magnitude, wherein the vector ( [symbol] ₘₐₓ) or its opposite vector (− [symbol] ₘₐₓ) points toward said first housing opening.

27. A field device, comprising:
an RFID system as claimed in claim 26.

28. Use of an apparatus as claimed in claim 15 for Bluetooth (IEEE 802.15.1), WLAN (IEEE 802.15.1), HIPERLAN, IWLAN, wireless HART and NFC.
